(19) United States
(12) Patent Application Publication
(10) Pub. No.: US 2017/0313425 A1
(43) Pub. Date: Nov. 2, 2017

(54) Avionics system for assisting implementation of security measures onboard an aircraft, aircraft comprising such a system, and associated method

(71) Applicant: DASSAULT AVIATION, Paris (FR)

(72) Inventor: Mathieu SENET, MARTIGNAS-SUR-JALLE (FR)

(21) Appl. No.: 15/497,916

(22) Filed: Apr. 26, 2017

(30) Foreign Application Priority Data
Apr. 28, 2016 (FR) FR 16 00713

(51) Int. Cl. B64D 11/00; B64D 45/00

(52) U.S. Cl. CPC B64D 11/0015; B64D 45/00

(57) ABSTRACT

Avionics system for assisting implementation of security measures onboard an aircraft, aircraft comprising such a system, and associated method are provided. The avionics system is intended to assist the occupants of an aircraft in implementing security measures onboard the aircraft. It includes a parameter collector for collecting at least one avionics parameter of the aircraft, a context finder to determine a context from the or each avionics parameter collected by the collector, an instruction identifier to identify at least one relevant security instruction based on the context determined by the context finder, and at least one instruction submitter to submit the or each relevant security instruction to a passenger of the aircraft.

This claims the benefit of French Patent Application FR 16 00713, filed Apr. 28, 2016 and hereby incorporated by reference herein.

The present invention relates to an avionics system for assisting the implementation of security measures onboard an aircraft.

The invention also relates to an aircraft comprising such an avionics system, and an associated method for assisting the implementation of security measures onboard an aircraft.

### BACKGROUND

Aircraft certification requires compliance with certain security measures during critical flight phases of the aircraft, in particular during takeoff and landing. These security measures in particular include the return of passengers to their respective seats, fastening seatbelts, closing cabinets, and returning configurable equipment, such as reclining chairs and tray tables, to a so-called secure configuration.

In order for the security measures to be respected, the certification requires that aircraft be equipped so as to show passengers regulated security instructions pertaining to the measures to be respected. These security instructions are most often presented in the form of screen printed or etched elements, panels or labels attached on the equipment and each bearing text and/or an icon mentioning a security measure to be respected, as well as the flight phase during which this security measure must be carried out. Some security instructions can be backlit, for example when ordered by the pilot or crew of the aircraft, the illuminated state of the security instruction meaning that it must be applied.

This need to provide information to passengers, combined with the increasingly complex layouts of aircraft cabins multiplying the lighted panels and configurable equipment, has led to a significant increase in placards and stickers mentioning security instructions, to the point that the aesthetics of the insides of cabins are now significantly deteriorated by the presence of these placards and stickers. Furthermore, this information overload increasingly frequently leads passengers to ignore the security instructions, or to forget to apply them at the applicable moments.

### SUMMARY OF THE INVENTION

One aim of the invention is to reduce the space occupied by the display of security instructions, while allowing aircraft passengers to be sufficiently informed, meeting the requirements set out by the regulations. Another aim is to simplify the monitoring of compliance with security instructions.

An avionics system of the aforementioned type is provided, comprising:
a parameter collector for collecting at least one avionics parameter of the aircraft,
a context finder to determine a context from the or each avionics parameter collected by the collector,
an instruction identifier to identify at least one relevant security instruction based on the context determined by the context finder, and
at least one instruction submitter to submit the or each relevant security instruction to a passenger of the aircraft.

According to specific embodiments of the invention, the avionics system also comprises one or more of the following features, considered alone or according to any technically possible combination(s):
the avionics system comprises a database storing a plurality of storage security instructions each associated with a predetermined applicability context, the instruction identifier being configured to identify the or each stored security instruction, whose applicability context consists of the context determined as making up a relevant security instruction;
the stored security instructions are each associated with a respective instruction submitter, and each instruction submitter is configured to submit only relevant security instructions associated with said instruction submitter;
each of the relevant security instructions is associated with a priority order, and the or each instruction submitter is configured to submit the relevant security instructions successively based on their priority order;
the avionics system comprises an instruction sequencer to determine the priority order of each relevant security instruction based on the context;
the avionics system comprises at least one acceptance member able to be actuated by a passenger of the aircraft, the or each acceptance member being associated with a respective instruction submitter;
the or each instruction submitter is configured to wait for the acceptance member associated with said instruction submitter to be actuated before submitting, after a first security instruction, a second security instruction having a priority order lower than the priority of the first relevant security instruction,
the avionics system comprises a system for verifying the acceptance of the or each relevant security instruction by the passenger of the aircraft, said verification system comprising a member for identifying an acceptance state of each relevant security instruction, configured to impart an accepted value to the acceptance state of a relevant security instruction when an acceptance member is actuated while said relevant instruction is displayed by the instruction submitter with which the acceptance member is associated;
the verification system comprises a verification viewer to display the acceptance state of the or each relevant security instruction;
the avionics system comprises a sensor system associated with at least one piece of equipment of the aircraft to detect a configuration of said piece(s) of equipment, and a monitoring system to monitor, for the or each relevant security instruction, the application of said relevant security instruction, said monitoring system comprising a member for deducing an application state of the or each relevant security instruction based on the configuration detected by the sensor system;
the monitoring system comprises a monitoring viewer to display the application state of the or each relevant security instruction;
a viewable instruction is associated with the or each relevant security instruction, and the or each instruction submitter comprises a display viewer in order to show the associated viewable instruction for the or each relevant security instruction submitted by said instruction submitter; and
the or each instruction submitter comprises an audio device configured to emit a sound upon each new display of a relevant security instruction by said instruction submitter.

An aircraft comprising an avionics system as described above is also provided.

A method for assisting the implementation of security measures onboard an aircraft is also provided, comprising the following steps:
collecting at least one avionics parameter of the aircraft,
determining a context from the or each collected avionics parameter,
identifying at least one relevant security instruction based on the context determined, and
submitting the or each relevant security instruction to a passenger of the aircraft.

According to specific embodiments of the invention, the assistance method also comprises one or more of the following features, considered alone or according to any technically possible combination(s):
submitting the or each relevant security instruction comprises temporarily submitting a viewable instruction associated with the relevant security instruction.
security instructions are stored in a database, each being associated with a predetermined context, and the or each relevant instruction is made up of a stored security instruction associated with the determined context,
the method comprises a step for a passenger to signal acceptance of a displayed security instruction,
the step for signaling acceptance of a displayed security instruction comprises the actuation, by the user, of an acceptance member associated with a respective instruction submitter while said instruction submitter is submitting said displayed security instruction,
the step for displaying relevant security instructions comprises a first step for displaying a first relevant security instruction, followed by a second step for displaying a second relevant security instruction, the second display step following the signaling of acceptance of the first relevant security instruction or occurring upon expiration of a predetermined length of time after beginning the first display step,
the method comprises a step for verifying the acceptance of the or each relevant security instruction by the passenger of the aircraft, said verification step comprising the display of an acceptance state of said relevant security instruction on a verification viewer, for the or each relevant security instruction,
the method comprises a step for detecting a configuration of the aircraft cabin and a step for monitoring the application of the or each relevant security instruction, the monitoring step comprising deducing an application state of the or each relevant security instruction based on the cabin configuration;
the monitoring step comprises a step for displaying, on a monitoring viewer and for the or each relevant security instruction, the application state of said relevant security instruction; and
the assistance method is implemented by an avionics system as defined above.

### BRIEF SUMMARY OF THE DRAWINGS

Other features and advantages of the invention will appear upon reading the following description, provided solely as an example and done in reference to the appended drawings, in which:

FIG. 1 is a schematic elevation and partial sectional view of an aircraft according to an embodiment the invention,

FIG. 2 is a block diagram of a first alternative of an avionics system equipping the aircraft of FIG. 1 for assisting implementation of security measures onboard this aircraft,

FIG. 3 is a block diagram of a second alternative of the avionics system of FIG. 2,

FIG. 4 is a block diagram of a third alternative of the avionics system of FIG. 2, and

FIG. 5 is a block diagram illustrating a method implemented by the avionics system of FIG. 2.

### DETAILED DESCRIPTION

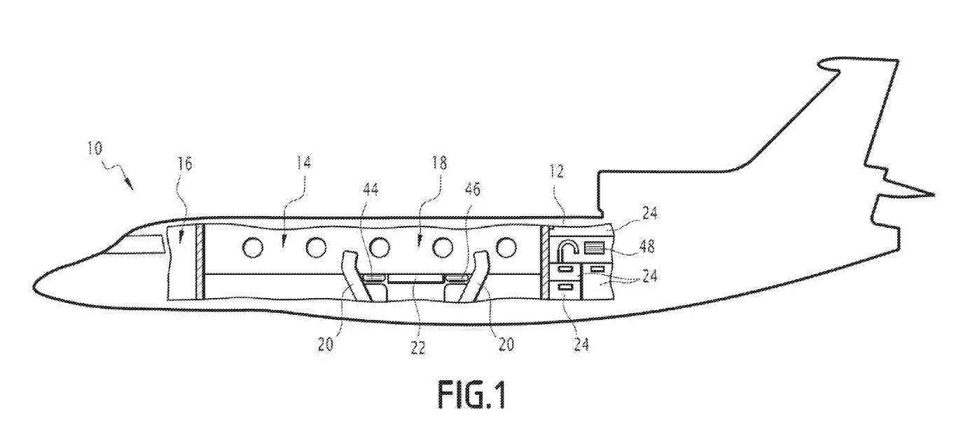

The aircraft 10 shown in FIG. 1 is an airplane. In a known manner, this aircraft 10 comprises a fuselage 12 defining an inner passenger compartment 14. The inner passenger compartment 14 is divided into a cockpit 16, the use of which is reserved for the pilots of the aircraft 10, and a cabin 18 intended to accommodate passengers, said cabin extending from behind the cockpit to the baggage hold space.

The cabin 18 contains cabin equipment 20, 22, 24. This cabin equipment 20, 22, 24 in particular comprises configurable equipment 20, 22, including reclining chairs 20 and a tray table 22, and cabinets 24. As indicated in the preamble of the present application, for security reasons, during certain critical flight phases of the aircraft 10, each piece of configurable equipment 20, 22 must be returned to a so-called “secure” configuration, and each cabinet 24 must be closed. It is thus necessary, during these critical flight phases of the aircraft 10, to perform certain actions, in particular on the configurable pieces of equipment 20, 22 and the cabinets 24, to place the cabin 18 in a so-called “secure” configuration. Here and below, we will describe these actions as “security measures”.

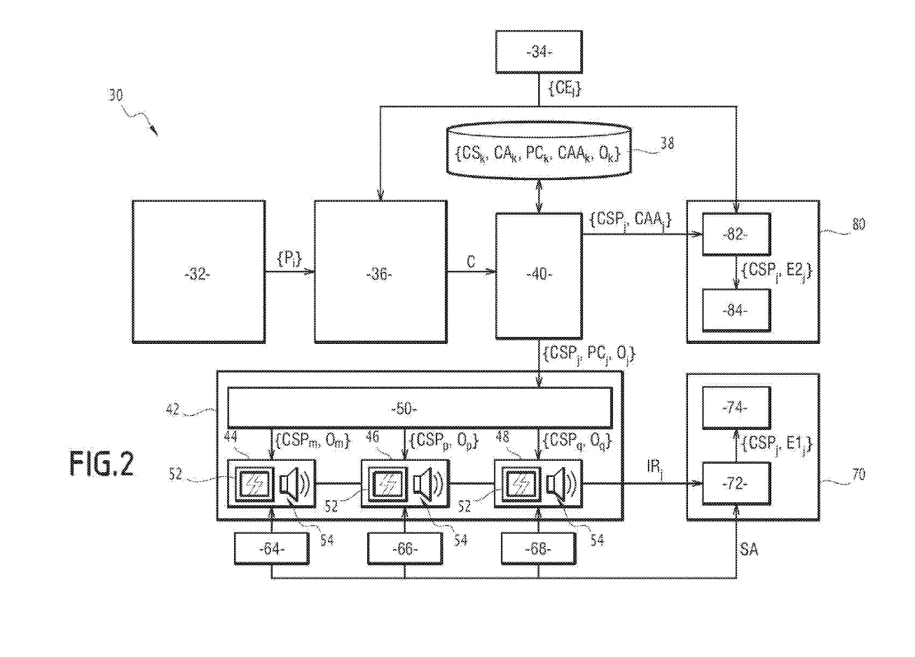

In order to facilitate the implementation of these security measures, the aircraft 10 comprises an avionics assistance system 30. FIG. 2 shows a first alternative of this system 30.

In reference to FIG. 2, the assistance system 30 comprises a parameter collector 32 for collecting at least one, preferably a plurality of avionics parameters Pᵢ of the aircraft, as well as a system of sensors 34 for detecting a measured configuration CEᵢ of each piece of cabin equipment 20, 22, 24 of the aircraft 10, and a context finder 36 for determining a security context C from the avionics parameters Pᵢ and the measured configuration CEᵢ of each piece of cabin equipment 20, 22, 24.

The avionics parameters Pᵢ are made up of the information produced by the avionics systems of the aircraft 10 and in particular relative to:
the configuration of the aircraft 10, i.e., the deployed or retracted state of a plurality of members of the aircraft 10 such as the leading-edge slats, the landing gear and/or the flaps,
the state of the aircraft 10, i.e., the operating or failure state of flight equipment of the aircraft 10,
the mission context, i.e., in particular the flight plan programmed into the flight management system of the aircraft 10,
environmental data, i.e., the weather conditions encountered by the aircraft 10, as well as the instructions sent to the aircraft 10 by the air control systems,
the current altitude of the aircraft 10, and
the flight phase of the aircraft 10.

In order to be able to collect these avionics parameters Pᵢ, the collector 32 is in communication with the other avionics systems of the aircraft 10, and is suitable for receiving the avionics parameters Pᵢ from these avionics systems. The collector 32 is also configured to send these avionics parameters Pᵢ to the context finder 36.

The measured configuration CEᵢ of each piece of cabin equipment 20, 22, 24 depends on the piece of cabin equipment 20, 22, 24 in question. For example, for each reclining chair 20, two configurations CEᵢ are detected: a first measured configuration CEᵢ relates to the inclined or upright position of the back of the reclining chair 20, and is typically detected by an end-of-travel sensor, and a second measured configuration CEᵢ relates to the presence or absence of a load on the seat bottom of the reclining chair 20, and is for example detected by a piezoelectric sensor housed in the seat bottom of the reclining chair 20. The measured configuration CEᵢ of the tray table 22 typically pertains to the retracted or deployed state of the tray table 22, detected for example using an end-of-travel sensor, and the measured configuration CEᵢ of each cabinet 24 typically pertains to the open or closed state of the cabinet 24, also detected with an end-of-travel sensor.

The set of measured configurations CEᵢ of the various pieces of cabin equipment 20, 22, 24 forms what will subsequently be referred to as a configuration of the cabin 18.

The system of sensors 34 is configured to send the measured configuration CEᵢ of each piece of cabin equipment 20, 22, 24 to the context finder 36.

The context finder 36 is configured to receive the avionics parameters Pᵢ and the measured configurations CEᵢ of the different pieces of cabin equipment 20, 22, 24, and to analyze these parameters Pᵢ and configurations CEᵢ so as to determine the context C.

The avionics system 30 also comprises a database 38 storing a plurality of storage security instructions CSₖ, and an instruction identifier 40 to identify relevant security instructions CSPⱼ from among the storage security instructions CSₖ, based on the context C determined by the context finder 36. The avionics system 30 further comprises a submission system 42 with a plurality of instruction submitters 44, 46, 48 to submit the relevant security instructions CSPⱼ to the passengers of the aircraft 10.

Each stored security instruction CSₖ is associated in the database 38 with an applicability context CAₖ of the security instruction CSₖ, an instruction submitter identifier PCₖ designating one of the instruction submitters 44, 46, 48, and a post-application configuration CAAₖ representative of the configuration that one of the pieces of cabin equipment 20, 22, 24 must occupy after the storage security instruction CSₖ has been applied.

Each stored security instruction CSₖ is also associated with a specific priority order Oₖ in the database 38. This priority order Oₖ is determined based on the criticality (minor, major, dangerous or catastrophic) of events that may be caused by the failure to send said security instruction CSₖ when this security instruction CSₖ is a relevant security instruction CSPⱼ, and the likelihood of occurrence (extremely unlikely, extremely rare, rare or likely) of these events, such that the security instructions CSₖ which, if not sent, may cause the most critical events with the highest likelihoods are associated with the highest priority orders Oₖ. Thus, each stored security instruction CSₖ which, if not sent, may cause an event with a given criticality and a given likelihood is associated with a priority order Oₖ higher than the priority order Oₖ associated with each other stored security instruction CSₖ which, if not sent, may only cause events with a criticality lower than the given criticality, with an occurrence likelihood lower than or equal to the given occurrence likelihood, and events with a criticality lower than or equal to the given criticality with an occurrence likelihood lower than the given occurrence likelihood.

The instruction identifier 40 is in communication with the database 38 and is configured to receive the determined context C from the context finder 36. The instruction identifier 40 is also configured to identify each stored security instruction CSₖ whose applicability context CAₖ is the context C determined as making up one of the relevant security instructions CSPⱼ.

The instruction identifier 40 is lastly configured to send the submission system 42 each of the identified relevant security instructions CSPⱼ with, for each instruction CSPⱼ, the instruction submitter identifier PCⱼ and the priority order Oⱼ with which it is associated.

The submission system 42 is configured so that each instruction submitter 44, 46, 48 only submits the relevant instructions CSPⱼ associated with an instruction submitter identifier PCⱼ identifying it. To that end, the submission system 42 comprises a sorting member 50 suitable for sorting the relevant security instructions CSPⱼ based on instruction submitter identifiers PCⱼ with which they are associated and sending each instruction submitter 44, 46, 48, respectively, only the relevant security instructions CSPₘ, CSPₚ, CSP_{q}, associated with an instruction submitter identifier PCⱼ identifying it.

It will be noted that in the example shown in FIG. 1, the instruction submitters 44, 46, 48 comprise two submitters 44, 46 each positioned near a respective reclining chair 20, and a submitter 48 positioned near the cabinets 24. The stored instructions CSₖ associated with the instruction submitters 44, 46 thus preferably comprise instructions relative to placing the reclining chairs 20 in the upright position and stowing the tray table 22, and the stored instructions CSₖ associated with the instruction submitter 48 preferably comprise instructions relative to closing the cabinets 24.

Each stored security instruction CSₖ, and therefore each relevant security instruction CSPⱼ, preferably comprises a viewable instruction. In order to allow this instruction to be submitted, each instruction submitter 44, 46, 48 comprises, as shown in FIG. 2, a display viewer 52 configured to display the viewable instructions of the relevant security instructions CSPⱼ that are associated with it.

Advantageously, each instruction submitter 44, 46, 48 also comprises, as shown, an audio device 54 configured to emit a sound upon each new submission of a relevant security instruction CSPⱼ by said instruction submitter 44, 46, 48, this sound preferably being formed by a beep and/or by the reading, by a recorded voice or a synthetic voice, of the viewable instruction.

The avionics system 30 further comprises acceptance members 64, 66, 68, respectively, each associated with a respective instruction submitter 44, 46, 48, respectively.

Each acceptance member 64, 66, 68 can be actuated by the passengers. Each acceptance member 64, 66, 68 is in particular intended to be actuated by a passenger when this passenger has seen the relevant security instructions CSPⱼ submitted by the instruction submitter 44, 46, 48 with which the acceptance member 64, 66, 68 is associated; to that end, the acceptance member 64, 66, 68 is for example positioned near the viewer 52 of the instruction submitter 44, 46, 48 with which it is associated.

Each instruction submitter 44, 46, 48, respectively, is configured to submit the relevant security instructions that are assigned to it, CSPm, CSPₚ, CSP_{q}, successively based on their respective priority orders, Oₘ, Oₚ, O_{q}, respectively. In particular, each instruction submitter 44, 46, 48 is configured to first submit the relevant security instruction CSPⱼ that, among that the relevant security instructions CSPₘ, CSPₚ, CSP_{q} that are assigned to it, has the highest priority order Oⱼ, then the relevant security instruction CSPₘ, CSPₚ, CSP_{q} that is assigned to it whose priority order Oₘ, Oₚ, O_{q} comes immediately afterwards, and so forth.

Preferably, each instruction submitter 44, 46, 48, respectively, is configured to submit the relevant security instructions CSPₘ, CSPₚ, CSP_{q} that are assigned to it according to one of the submission alternatives described below.

According to a first submission alternative, the instruction submitter 44, 46, 48 is configured to submit all of the relevant security instructions CSPₘ, CSPₚ, CSP_{q} that are assigned to it at the same time, during the entire duration during which said instructions CSPₘ, CSPₚ, CSP_{q} remain relevant.

According to a second submission alternative, the instruction submitter 44, 46, 48 is configured to wait for the expiration of a predetermined duration after the beginning of the submission of a first relevant security instruction CSPⱼ before submitting, as a replacement for said first relevant security instruction CSPⱼ, a second relevant security instruction CSPⱼ having a priority order Oⱼ lower than the priority order Oⱼ of the first relevant security instruction CSPⱼ.

According to a third submission alternative, the instruction submitter 44, 46, 48 is configured to wait for the expiration of a predetermined duration after the beginning of the submission of a first relevant security instruction CSPⱼ before submitting, as a replacement for said first relevant security instruction CSPⱼ, a second relevant security instruction CSPⱼ having a priority order Oⱼ lower than the priority order Oⱼ of the first relevant security instruction CSPⱼ, while being configured to submit the second relevant security instructions CSPⱼ as a replacement for the first relevant security instruction CSPⱼ before the expiration of said predetermined duration when the acceptance member 64, 66, 68 associated with said instruction submitter 44, 46, 48 is actuated.

Lastly, according to a fourth submission alternative, the instruction submitter 44, 46, 48 is configured to wait, without time limit, for the actuation of the acceptance member 64, 66, 68 associated with said instruction submitter 44, 46, 48 before submitting, as a replacement for the first relevant security instruction CSPⱼ, the second relevant security instruction CSPⱼ.

Advantageously, all of the instruction submitters 44, 46, 48 are not configured to submit the relevant security instructions CSPₘ, CSPₚ, CSP_{q} that are assigned to them according to a same submission alternative. In other words, at least one instruction submitter 44, 46, 48 configured to submit the relevant security instructions CSPₘ, CSPₚ, CSP_{q} that are assigned to it according to a submission alternative different from that according to which at least one other instruction submitter 44, 46, 48 is configured to submit the relevant security instructions CSPₘ, CSPₚ, CSP_{q} that are assigned to it.

The avionics system 30 further comprises a verification system 70 verifying the acceptance of each relevant security instruction CSPⱼ by the passengers of the aircraft 10. This verification system 70 comprises a member 72 for identifying an acceptance state E1ⱼ of each relevant instruction CSPⱼ, and a verification viewer 74 to display the acceptance state E1ⱼ of each relevant instruction CSPⱼ.

The identification member 72 is configured to receive, for each acceptance member 64, 66, 68, an actuating signal SA of the acceptance member 64, 66, 68 by a passenger of the aircraft 10. The identification member 72 is also configured to receive, for each instruction submitter 44, 46, 48, a piece of information IRⱼ representative of the relevant instruction CSPⱼ shown by said instruction submitter 44, 46, 48 at the moment at which the acceptance member 64, 66, 68 associated with said instruction submitter 44, 46, 48 has been actuated.

The identification member 72 is further configured to assign the acceptance state E1ⱼ of each relevant instruction CSPⱼ an initial non-accepted value, and to convert this initial value into a subsequent accepted value when the relevant instruction CSPⱼ is shown by an instruction submitter 44, 46, 48 at the moment when the acceptance member 64, 66, 68 associated with said instruction submitter 44, 46, 48 is actuated.

The verification viewer 74 is advantageously intended to be viewed by the onboard personnel, in particular by the pilots. To that end, the verification viewer 74 is preferably positioned in the cockpit 16.

The avionics system 30 further comprises a monitoring system 80 to monitor, for each relevant security instruction CSPⱼ, the application of said relevant security instruction CSPⱼ. To that end, the monitoring system 80 comprises a member 82 for deducing an application state E2ⱼ of each relevant security instruction CSPⱼ, and a monitoring viewer 84 to display the application state E2ⱼ of each relevant instruction CSPⱼ.

The deducing member 82 is configured to receive the measured configuration CEⱼ of each piece of cabin equipment 20, 22, 24 from the system of sensors 34, and to receive each relevant security instruction CSPⱼ and the post-application configuration CAAⱼ with which it is associated from the instruction identifier 40. The deducing member 82 is also configured to deduce the application state E2ⱼ of each relevant security instruction CSPⱼ from these data. In particular, the deducing member 82 is configured to compare, for each relevant security instruction CSPⱼ, the post-application configuration CAAⱼ with which said relevant security instruction CSPⱼ is associated with the measured configuration CE₁ of each piece of cabin equipment 20, 22, 24, and to deduce therefrom that the application state E2ⱼ of said relevant security instruction CSPⱼ has the value:
applied, when the post-application configuration CAAⱼ with which the relevant security instruction CSPⱼ is associated corresponds to one of the measured configurations CE₁, or
not applied when the post-application configuration CAAⱼ with which the relevant security instruction CSPⱼ is associated does not correspond to any of the measured configurations CE₁.

The monitoring viewer 84 is advantageously intended to be viewed by the onboard personnel, in particular by the pilots. To that end, the monitoring viewer 84 is preferably positioned in the cockpit 16.

Advantageously, the verification 74 and monitoring 84 viewers are merged into a single viewer for example belonging to the electronic flight bag of the aircraft 10.

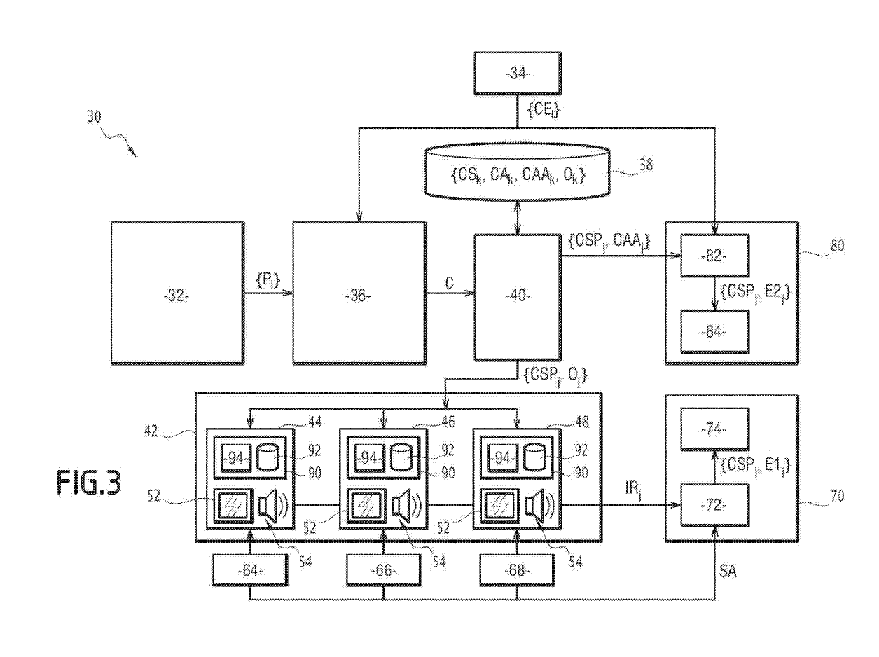

The second alternative of the assistance system 30, shown in FIG. 3, only differs from the first alternative of FIG. 2 for the features set out below.

Unlike the first alternative, the assistance system 30 in the second alternative does not comprise a sorting member 50, and no instruction submitter identifier PCₖ, PCⱼ is associated with the security instructions CSₖ, CSPⱼ. In this alternative, the instruction identifier 40 is configured to send each relevant security instruction CSPⱼ, with its associated priority order Oⱼ, to each instruction submitter 44, 46, 48.

Each instruction submitter 44, 46, 48 then comprises a filter 90 for filtering the received relevant security instructions CSPⱼ, and is configured to submit only the relevant instructions CSPⱼ whose transmission is not blocked by the filter 90.

The filter 90 comprises a database 92 containing a list of authorized instructions for the instruction submitter 44, 46, 48, and an instruction comparator 94 configured to compare each received relevant security instruction CSPⱼ to the authorized instructions contained in the list and to determine, based on this comparison, whether the relevant instruction CSPⱼ can be sent for submission or must be blocked. The instruction comparator 94 is in particular configured to authorize the transmission of a received relevant security instruction CSPⱼ when this instruction CSPⱼ corresponds to one of the authorized security instructions, and to block said transmission when the relevant security instruction CSPⱼ does not correspond to any of the authorized security instructions.

This second alternative makes it possible to facilitate the management of the submission of relevant security instructions CSPⱼ by the instruction submitters 44, 46, 48, in particular by making the assistance system 30 more configurable, and improves the overall reliability of the system 30.

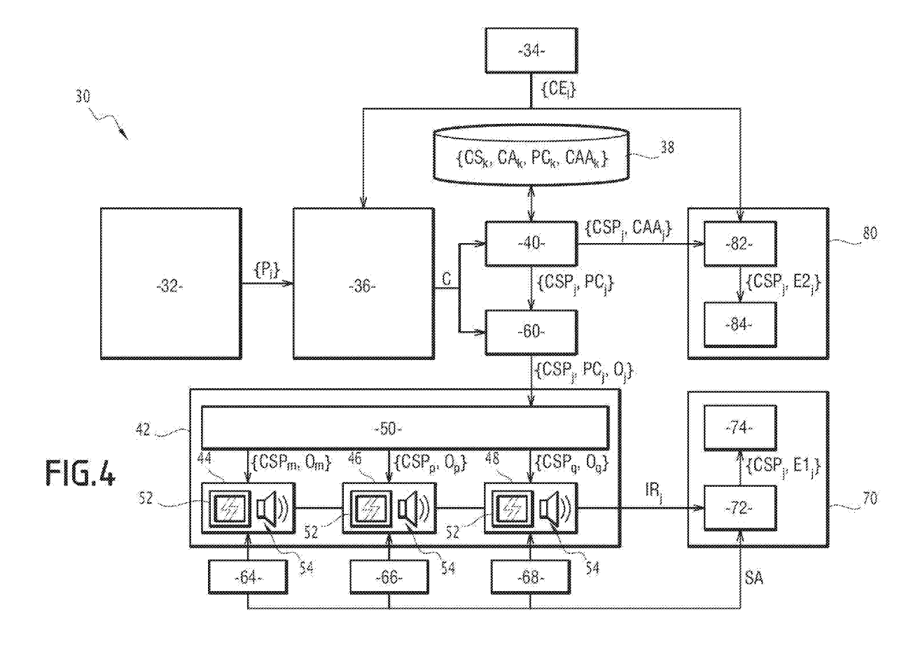

The third alternative of the assistance system 30, shown in FIG. 4, only differs from the first alternative of FIG. 2 for the features set out below.

Unlike the first alternative, each stored security instruction CSₖ is not, in this third alternative, associated with a priority order Oₖ in the database 38. As a replacement, the assistance system 30 in this third alternative comprises an instruction sequencer 60 configured to determine the priority order Oⱼ of each relevant security instruction CSPⱼ.

The instruction sequencer 60 is in particular configured to receive the relevant security instructions CSPⱼ and the instruction submitter identifiers PCⱼ from the instruction identifier 40, to receive the determined context C from the context finder 36, and to determine the priority order Oⱼ of each relevant security instruction CSPⱼ based on the determined context C. To that end, the instruction sequencer 60 is configured to identify events that may be caused by the non-transmission of said relevant security instruction CSPⱼ, assess the contextual criticality (minor, major, dangerous or catastrophic), depending on the context C, and the contextual likelihood of occurrence (extremely unlikely, extremely rare, rare or likely), also depending on the context C, of these events, and associate the highest priority orders Oⱼ with the relevant security instructions CSⱼ whereof non-transmission is likely to cause events having the highest contextual criticalities with the highest contextual likelihoods of occurrence.

The instruction sequencer 60 is also configured to send the submission system 42 the priority order Oⱼ of each relevant security instruction CSPⱼ.

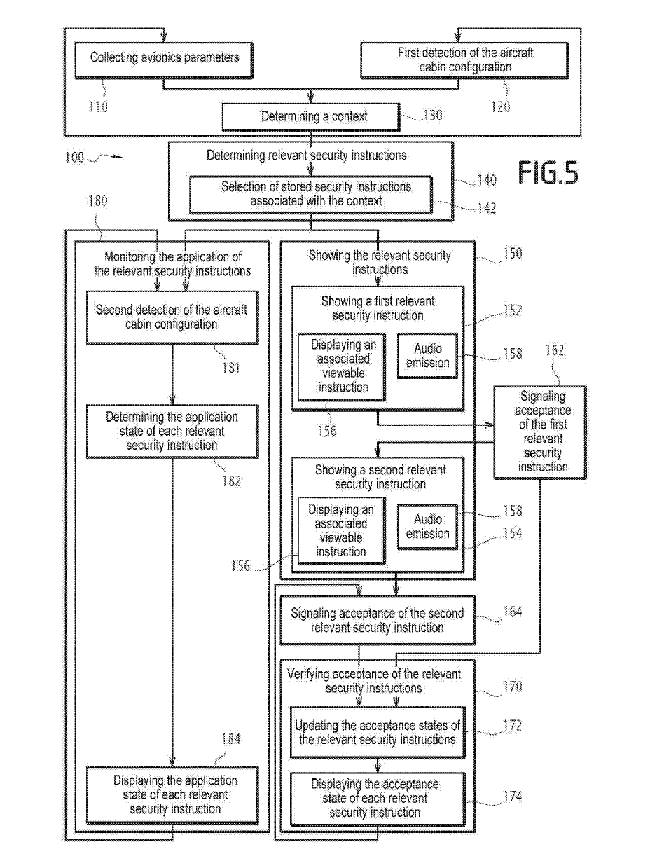

A method 100 for assisting with the implementation of security measures onboard the aircraft 10, implemented using the assistance system 30, will now be described in reference to FIG. 5.

This method 100 begins with a first step 110 for collecting avionics parameters, during which the collector 32 collects the avionics parameters Pᵢ from the other avionics systems.

This step 110 is accompanied by a step 120 for a first detection of the configuration of the cabin 18 of the aircraft 10, during which the system of sensors 34 detects the measured configurations CEᵢ of the various pieces of cabin equipment 20, 22, 24.

These steps 110, 120 are followed by a step 130 for determining a context, during which the context determiner 36 determines the context C using avionics parameters Pᵢ and measured configurations CEᵢ.

Steps 110, 120 and 130 are repeated all throughout the implementation of the method 100, so as to update the context C based on the evolution of the avionics parameters Pᵢ and measured configurations CEᵢ.

Step 130 is followed by a step 140 for identifying relevant security instructions, during which the instruction identifier 40 identifies the relevant security instructions CSPⱼ. This step 140 comprises a sub-step 142 for selecting stored security instructions CSₖ associated with the context C, during which the context identifier 40 selects the stored security instructions CSₖ associated with the context C from the database 38 and identifies them as constituting the relevant security instructions CSPⱼ.

Step 140 is followed by a step 150 for displaying relevant security instructions CSPⱼ, during which the relevant security instructions CSPⱼ are displayed by the instruction submitters 44, 46, 48. This display step 150 comprises a first sub-step 152 for displaying a first relevant security instruction, during which a first relevant security instruction CSPⱼ, associated with a first priority order Oᵢ, is displayed by a viewer 44, 46, 48, followed by a second sub-step 154 for submitting a second relevant security instruction, during which a second relevant security instructions CSPⱼ, associated with a second priority order Oⱼ lower than the first priority order, is displayed by the same viewer 44, 46, 48. Each of these sub-steps 152, 154, respectively, comprises a sub-step 156 for displaying an associated viewable instruction, during which the viewable instruction associated with the first, second, respectively, relevant security instruction CSPⱼ is temporarily displayed by the viewer 52 of the instruction submitter 44, 46, 48, and a simultaneous audio emission sub-step 158, during which a beep is emitted by the audio emitting device 54 of the instruction submitter 44, 46, 48.

In the case where, due to the evolution of the context C, a relevant security instruction CSPⱼ ceases to be relevant, the display of the latter is interrupted.

The method 100 also comprises a step 162 for signaling the acceptance of the first relevant security instruction, during which a passenger actuates the acceptance member 64, 66, 68 associated with the instruction submitter 44, 46, 48 submitting the first relevant security instruction CSPⱼ. This step 162 is concomitant with the step for submitting the first relevant security instruction 152 and precedes the step for submitting the second relevant security instruction 154.

The method 100 further comprises a step 164 for signaling the acceptance of the second relevant security instruction, during which a passenger actuates the acceptance member 64, 66, 68 associated with the instruction submitter 44, 46, 48 submitting the second relevant security instruction CSPⱼ. This step 164 is concomitant with the step for submitting the second relevant security instruction 154.

The method 100 also comprises a step 170 for verifying acceptance of the relevant security instructions CSPⱼ. This step 170 comprises a first sub-step 172 for updating the acceptance state E1ⱼ of each relevant security instruction CSPⱼ, during which the identification member 72 updates the acceptance states E1ⱼ of the relevant security instructions CSPⱼ based on the actuating signals SA of the acceptance members 64, 66, 68 that it receives. This first sub-step 172 is accompanied by a second sub-step for displaying the acceptance state E1ⱼ of each relevant security instruction CSPⱼ, during which the acceptance state E1ⱼ of each relevant security instruction CSPⱼ is displayed by the verification viewer 74, so as to inform the onboard personnel, in particular the pilots, of this acceptance state E1ⱼ,

Step 170 is repeated all throughout the implementation of the method 100.

The method 100 lastly comprises a step 180 for monitoring the application of the relevant security instructions CSPⱼ. This step 180 comprises a first sub-step 181 for a second detection of the configuration of the cabin 18 of the aircraft 10, during which the system of sensors 34 updates the measured configurations CEᵢ of the various pieces of cabin equipment 20, 22, 24. This first sub-step 181 is followed by a second sub-step 182 for producing the application state E2ⱼ of each relevant security instruction CSPⱼ, during which the deduction member 82 deduces the application state E2ⱼ of each relevant security instruction CSPⱼ based on the updated measured configurations CEᵢ. A third sub-step 184 for displaying the application state E2ⱼ of each relevant security instruction CSPⱼ follows the second step 182; during this third sub-step 184, the application state E2ⱼ of each relevant security instruction CSPⱼ is displayed by the monitoring viewer 84, so as to inform the onboard personnel, in particular the pilots, of this application E2ⱼ.

Step 180 is repeated all throughout the implementation of the method 100.

Owing to the method and system described above, it is thus possible to significantly reduce the space occupied by the display of security instructions, since only the security instructions relevant at a given moment will be displayed at that moment.

The method and system further allow better taking into account of security instructions by the passengers, since these instructions are only displayed when they must be taken into account. The temporary nature of this display then forces passengers to pay attention to the display.

Lastly, the method and system allow better monitoring of the taking account of security instructions and the application of these security instructions by the passengers, owing to the display of the acceptance E1ⱼ and application E2ⱼ states of the relevant security instructions CSPⱼ by the viewers 74, 84.

What is claimed is:

1. An avionics system for assisting in implementing security measures onboard an aircraft, the avionics system comprising:
a parameter collector configured for collecting at least one avionics parameter of the aircraft,
a context finder configured to determine a context from the or each avionics parameter collected by the collector,
an instruction identifier configured to identify at least one relevant security instruction based on the context determined by the context finder, and
at least one instruction submitter configured to submit the or each relevant security instruction to a passenger of the aircraft.

2. The avionics system according to claim 1, further comprising a database storing a plurality of storage security instructions each associated with a predetermined applicability context, the instruction identifier being configured to identify the or each stored security instruction, whose applicability context consists of the context determined as making up a relevant security instruction.

3. The avionics system according to claim 2, wherein the stored security instructions are each associated with a respective instruction submitter, and each instruction submitter is configured to submit only relevant security instructions associated with the instruction submitter.

4. The avionics system according to claim 1, wherein each of the relevant security instructions is associated with a priority order, and the or each instruction submitter is configured to submit the relevant security instructions successively based on the priority order of the relevant security instructions.

5. The avionics system according to claim 4, comprising an instruction sequencer to determine the priority order of each relevant security instruction based on the context.

6. The avionics system according to claim 1, further comprising at least one acceptance member configured for actuation by a passenger of the aircraft, the or each acceptance member being associated with a respective instruction submitter.

7. The avionics system according to claim 6, further comprising a system for verifying the acceptance of the or each relevant security instruction by the passenger of the aircraft, the verification system comprising a member for identifying an acceptance state of each relevant security instruction, configured to impart an accepted value to the acceptance state of a relevant security instruction when an acceptance member is actuated while the relevant instruction is submitted by the instruction submitter with which the acceptance member is associated.

8. The avionics system according to claim 7, wherein the verification system comprises a verification viewer to display the acceptance state of the or each relevant security instruction.

9. The avionics system according to claim 1, comprising a sensor system associated with at least one piece of cabin equipment of the aircraft to detect a configuration of the piece(s) of cabin equipment, and a monitoring system to monitor, for the or each relevant security instruction, the application of the relevant security instruction, the monitoring system comprising a member for deducing an application state of the or each relevant security instruction based on the configuration detected by the sensor system.

10. The avionics system according to claim 9, wherein the monitoring system comprises a monitoring viewer to display the application state of the or each relevant security instruction.

11. The avionics system according to claim 1, wherein a viewable instruction is associated with the or each relevant security instruction, and the or each instruction submitter comprises a submission display in order to show the associated viewable instruction for the or each relevant security instruction submitted by the instruction submitter.

12. An aircraft comprising an avionics system according to claim 1.

13. A method for assisting the implementation of security measures onboard an aircraft, comprising the following steps:
collecting at least one avionics parameter of the aircraft,
determining a context from the or each collected avionics parameter,
identifying at least one relevant security instruction based on the determined context, and
submitting the or each relevant security instruction to a passenger of the aircraft.

14. The assistance method according to claim 13, wherein submitting of the or each relevant security instruction comprises temporarily showing a viewable instruction associated with the relevant security instruction.

15. The assistance method according to claim 13, wherein security instructions are stored in a database, each being associated with a predetermined context, and the or each relevant instruction is made up of a stored security instruction associated with the determined context.

16. The assistance method according to claim 13, further comprising receiving a signal acceptance of a displayed security instruction from the passenger.

17. The assistance method according to claim 16, wherein the receiving a signal acceptance includes receiving the passenger's actuation of an acceptance member associated with a respective instruction submitter while the instruction submitter is submitting the displayed security instruction.

18. The assistance method according to claim 13, wherein displaying relevant security instructions comprises displaying a first relevant security instruction, followed by displaying a second relevant security instruction, the displaying of the second relevant security instruction following a signaling of acceptance of the first relevant security instruction or occurring upon expiration of a predetermined length of time after beginning the displaying of the first relevant security instruction.

19. The assistance method according to claim 13 further comprising verifying acceptance of the or each relevant security instruction by the passenger of the aircraft, the verifying comprising the display of an acceptance state of the relevant security instruction on a verification viewer, for the or each relevant security instruction.

20. The assistance method according to claim 13 further comprising detecting a configuration of the aircraft cabin and monitoring the application of the or each relevant security instruction, the monitoring comprising deducing an application state of the or each relevant security instruction based on the configuration of the aircraft cabin.
